(19) United States
(12) Patent Application Publication
(10) Pub. No.: US 2025/0023506 A1
(43) Pub. Date: Jan. 16, 2025

(54) SOLAR POWER SYSTEM, PLANT AND METHOD OF USE THEREOF

(71) Applicant: Narsimhan JAYARAM, Patterson Lakes (AU)

(72) Inventor: Narsimhan JAYARAM, Patterson Lakes (AU)

(21) Appl. No.: 18/689,593

(22) PCT Filed: Oct. 5, 2022
(86) PCT No.: PCT/AU2022/051185

§ 371 Date: Mar. 6, 2024

(30) Foreign Application Priority Data
Oct. 5, 2021 (AU) 2021903184
Mar. 30, 2022 (AU) 2022900825

(51) Int. Cl. H02S 20/23; H02S 30/20

(52) U.S. Cl. CPC H02S 20/23; H02S 30/20

(57) ABSTRACT

Disclosed herein is a solar panel system comprising at least one solar panel and a flexible support structure supporting the at least one solar panel wherein at least part of the flexible support structure is configured to be fillable with a fluid. Also disclosed is a solar power plant comprising said solar panel system and a method of using said solar power system.

### FIELD OF THE INVENTION

The present invention generally relates solar power systems, plants and a method of using the system or plant.

### BACKGROUND TO THE INVENTION

One of the difficulties in providing sufficient energy requirements to a population is in locating areas for the installation of power generating systems. Large cheap and available land can be generally only found remote from city or residential areas. These challenges can be compounded for populations living on remote islands or coastal regions.

Floating offshore solar power systems have been previously proposed to conveniently provide clean and green generation of energy where large areas of land are not readily available, for example on remote islands or coastal regions. Disadvantages of these currently proposed systems include exposure to the harsh weather conditions, such as wind, salt water, waves and currents, which can damage or corrode components of the systems. As such, these offshore solar power plants are typically limited to being located in sheltered areas and are not suitable or designed for open seas or oceans. In addition, it is difficult to maintain, repair or replace, clean and inspect these systems. The current deployment of these floating power systems is also labour-intensive and therefore expensive and cost-inefficient.

It is desirable for embodiments of the present invention to address at least partially one or more of the disadvantages of the methods or systems above. Further it is preferred that embodiments of the present invention provide a system or method for generating power which can provide one or more of the following: increased area for solar power generation, protection of the power systems from adverse weather conditions, and ease of maintenance, cleaning and inspection.

It is to be understood that, if any prior art publication is referred to herein, such reference does not constitute an admission that the publication forms a part of the common general knowledge in the art, in Australia or any other country.

### SUMMARY OF THE INVENTION

According to a first aspect of the present invention there is provided a solar panel system comprising: at least one solar panel; and a flexible support structure supporting the at least one solar panel; wherein at least part of the flexible support structure is configured to be fillable with a fluid.

At least part of the flexible support structure is configured to be fillable for the adjustment of buoyancy or weight. The at least part of the flexible support structure can be filled with gas. At least part of the flexible support structure may be filled with air or helium. Alternatively, the at least part of the flexible support structure is filled with water.

The at least part of the flexible support structure is configured to be fillable or able to be emptied for the adjustment of flexing properties of the support structure. The at least part of the flexible support structure may be fillable with a fluid, such as a gas or liquid.

In an embodiment, the pressure of the fluid is adjustable for adjustment of the properties.

The flexible support structure may be at least partly comprised of at least one fluid-fillable member. In one embodiment, the fluid-fillable member comprises a hose. The hose may be a collapsible hose. In an embodiment, the flexible support structure comprises a plurality of collapsible hoses.

As used herein, the term “collapsible hose” means a hose that may be filled with either a gas or a liquid. When unfilled, the collapsible hose has a substantially flat configuration but it assumes a more three dimensional configuration when filled with fluid.

The solar panel system can include a flexible sheet of material intermediate the flexible support structure and at least one solar panel. The flexible support structure can comprise a flexible sheet of material.

In another embodiment, the fluid-fillable member comprises a buoyancy member. This embodiment is primarily for use on water. Preferably, in this embodiment, the solar panel system includes at least one buoyancy member. The buoyancy members may be configured to be fillable to such an extent as to raise or lower the support structure in or on the water. The pressure of the fluid in the at least one buoyancy member can be adjustable to effect extension or retraction of the at least one buoyancy member.

In another embodiment, the flexible support structure is adapted so as to be retractable into a compact configuration for storage and deployable into an extended or expanded configuration for generation of solar power. The flexible support structure can be filled with the fluid when deployed for effecting rigidity and further wherein the fluid is removable for retraction into the compact configuration.

The system can further comprise a reel assembly having a reel member, wherein the flexible support structure is configured so as to be wound onto the reel member into the compact configuration and unwound so as to deploy the solar panel system into the expanded configuration.

In an embodiment, the support structure comprises a series of sheet materials, each sheet material being in the form of a panel, each of the panels of sheet material supporting one or more solar panels, and wherein the panels are connected so as to be foldable into a compact configuration and unfoldable so as to be deployed in the expanded configuration. The panels may be connected in a concertina arrangement. The compact configuration can be a stacked configuration having multiple flexible solar panels. The multiple solar panels are provided in an array or a linear series of panels connected end to end. The multiple solar panels can be electrically connected end-to-end in series.

The sheet of material can comprise a polymer, rubber or woven material.

According to a second aspect of the present invention there is provided a solar panel system comprising: at least one solar panel; and a flexible support structure supporting the at least one solar panel; wherein the flexible support structure is adapted so as to be retractable into a compact configuration for storage and deployable into an extended configuration for generation of solar power.

According to a third aspect of the present invention there is provided a solar power plant comprising one or more of the solar power systems according to the first or second aspects.

The solar power plant or solar power system can include one or more of the following: wiring and instrumentation for effecting solar power generation; hydrogen plant; wave energy converter; wind turbine generation; pipes for carrying sea water for desalinisation plant; batteries for storing power; storage for hydrogen, ammonia and/or oxygen; power, power conditioning and control management systems. The solar plant or solar power system can also include a HVDC transformer which converts the high voltage which results when connecting the panels in series. The HVDC preferably comprises a DC to AC Converter and then an AC Transformer to condition to any power requirements, such as any grid power requirements.

The solar power plant or system can be installed on a land vehicle wherein the solar panel system is deployable on land. The solar power plant or system can be deployed on a roof of a house or for off-shore use. The solar power plant or system can be installed on a marine or fresh water vehicle wherein the solar panel system is deployable on a surface of water.

According to a fourth aspect of the present invention there is provided a method of using a solar power system comprising at least one solar panel and a flexible support structure supporting the at least one solar panel: comprising deploying the flexible support structure into an expanded configuration for generation of solar power; retracting the flexible support structure into a compact configuration.

The method can include that the flexible support structure is fillable with fluid, wherein method includes: filling the support structure with fluid for adjustment of properties of the support structure when deployed. The method can also include removing fluid from the support structure for retracting the flexible support structure in the compact configuration.

### BRIEF DESCRIPTION OF THE DRAWINGS

One or more embodiments of the present invention will hereinafter be described with reference to the accompanying Figures, in which:

FIG. 1 is a front view of a solar panel system having a support structure and solar panels according to a preferred embodiment of the present invention;

FIG. 2 is a side view of FIG. 1;

FIG. 3 is a side view of a ship on which the solar panel system is installed;

FIG. 4 is a top view of FIG. 3;

FIG. 5 is a perspective close up view of the solar panel system having a reel assembly during deployment;

FIG. 6 is a top view of FIG. 5;

FIG. 7 is a perspective of the support structure including a rack-type arrangement having buoyancy members;

FIG. 8 is a top view of the solar panel system of FIGS. 5 and 6 in a deployed configuration;

FIG. 9 is a top view of the solar panel system having buoyancy members which are configured to raise and lower the solar panels;

FIG. 10 is a side view of the solar power plant having the solar panel system of FIG. 9 installed on a ship;

FIG. 11 is a perspective view of the solar panel system of FIG. 9;

FIG. 12 is a top view of a solar power plant having the solar panel system of FIGS. 1 and 2 in the form of a ship-shaped floating platform;

FIG. 13 is a perspective view of the solar power plant of FIG. 12;

FIG. 14 is a top view of a solar power plant having the solar panel system of FIGS. 1 and 2 in the form of a square-shaped floating platform;

FIG. 15 is a perspective view of FIG. 14;

FIG. 16 is a perspective view of FIG. 10;

FIG. 17 is a top view of the solar power plant of FIGS. 12 and 13 including a wave energy converter and wind turbine generator;

FIG. 18 is a perspective view of FIG. 17;

FIG. 19 is an expanded perspective view of another solar power system having a support structure in the form of a collapsible hose on which solar panels are mounted according to another embodiment of the present invention;

FIG. 20 is another solar power system having six collapsible hoses as shown in FIG. 19;

FIG. 21 is a perspective view of the solar power system of FIG. 20 on a reel assembly for deploying and retracting the solar panels;

FIG. 22 is a perspective view of the solar power system of FIG. 19 where the solar panels are stitched to the collapsible hose;

FIG. 23 is a perspective view of an alternative solar power system where the solar panels are stitched to a sheet material;

FIG. 24 is a perspective view of yet another solar power system having support structure in the form of sheet material which is supported by collapsible hoses according to a yet further preferred embodiment of the present invention;

FIG. 25 is a perspective view of the solar power system of FIG. 24 having the collapsible hoses in an inflated condition;

FIG. 26 is a top view of a solar power plant in the form of a ship installed with a plurality of solar power systems of FIG. 25 in a deployed configuration;

FIG. 27a is a side view of the solar power plant of FIG. 26 where the solar power systems are in compact configurations;

FIG. 27b is a top view of FIG. 27a;

FIG. 28 is a perspective view of a solar power system having a support structure of a sheet material in the form of a panel supporting the solar panels according to yet another preferred embodiment of the present invention;

FIGS. 29, 30 and 31 are perspective views of the solar power system in separated and stacked configurations respectively;

FIG. 32 is a solar power plant in the form of a ship having the solar power system of FIGS. 29, 30 and 31;

FIG. 33 is a perspective view of an enclosure for housing the solar panel system of FIGS. 28 to 31;

FIGS. 34 and 34 are perspective view of the solar power system of FIGS. 28 to 31 in deflated and inflated conditions; and

FIGS. 36a to 36c are top, front and side views of the enclosure of FIG. 33.

### DETAILED DESCRIPTION OF THE DRAWINGS

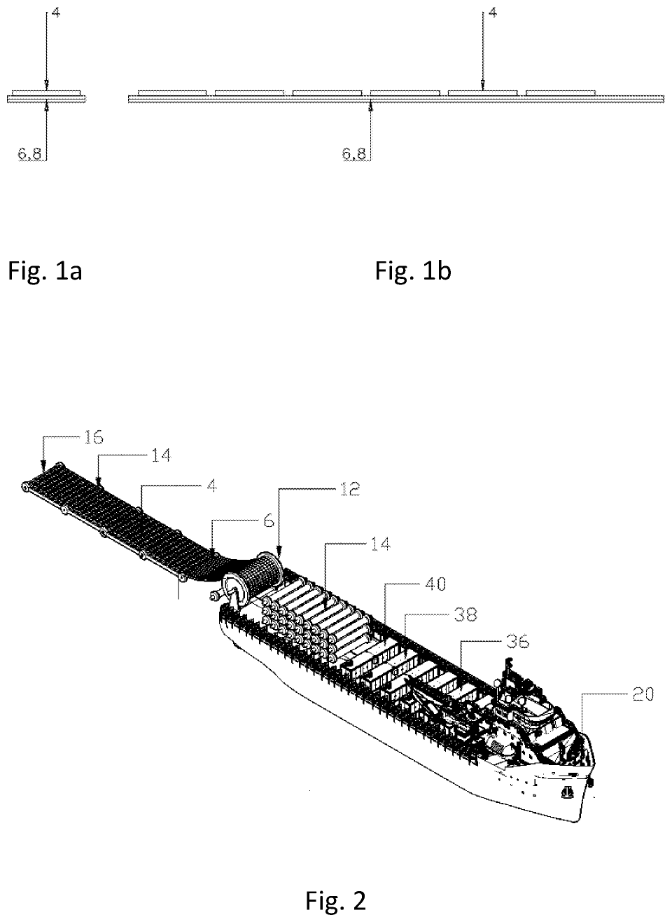

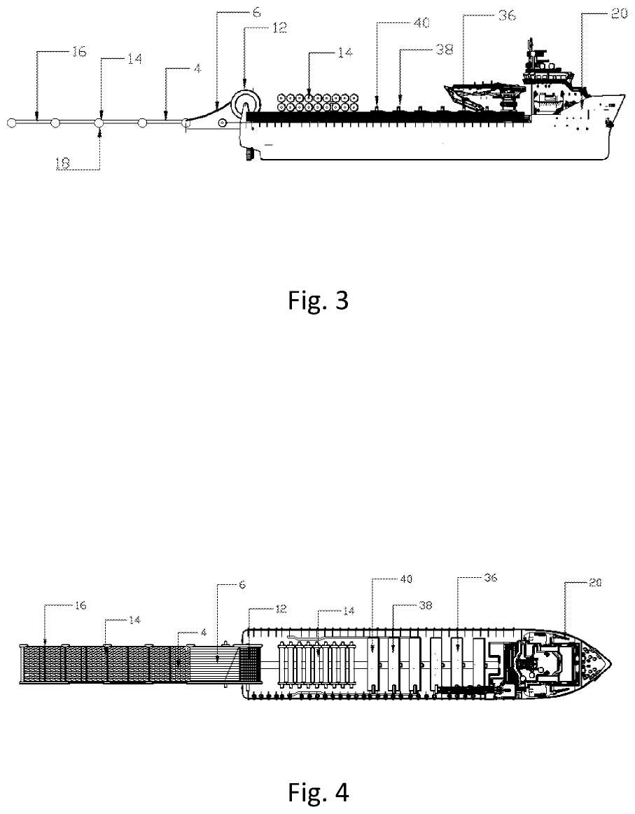

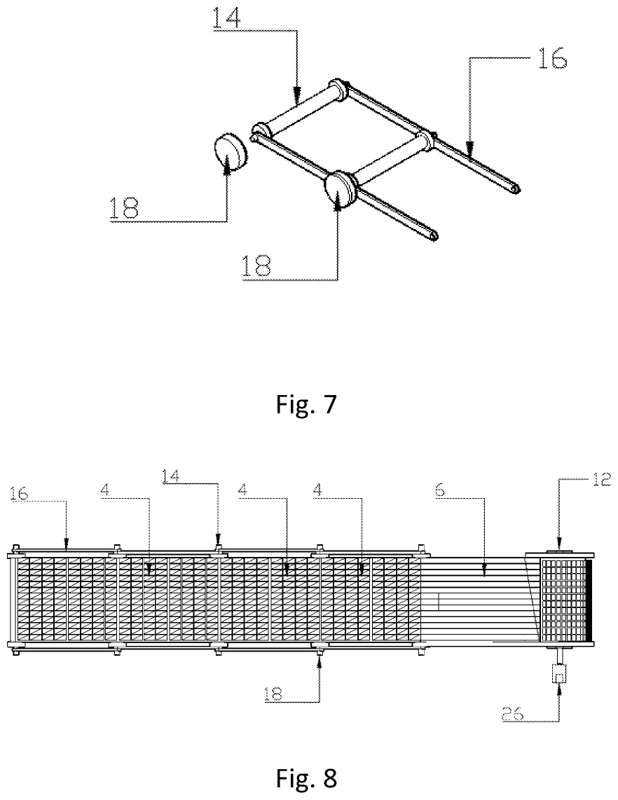

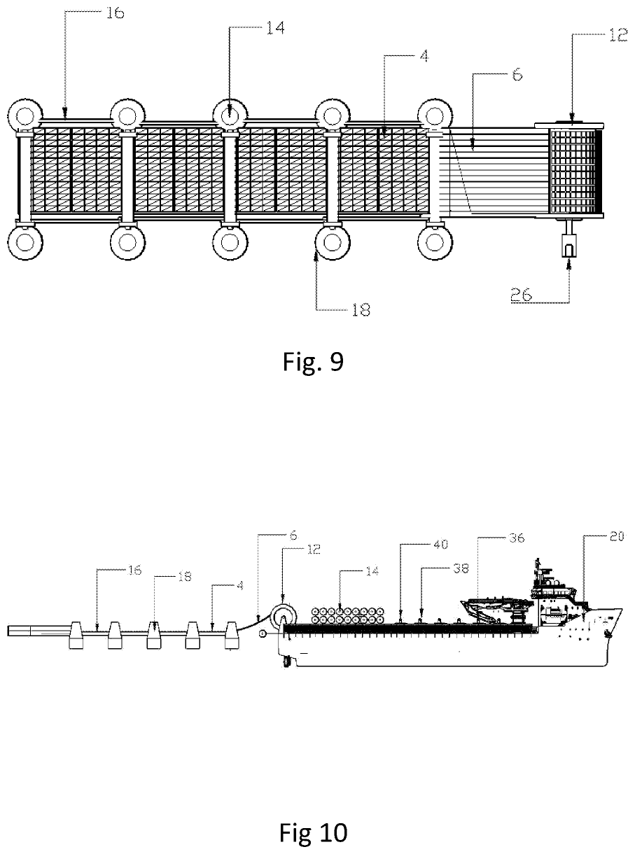

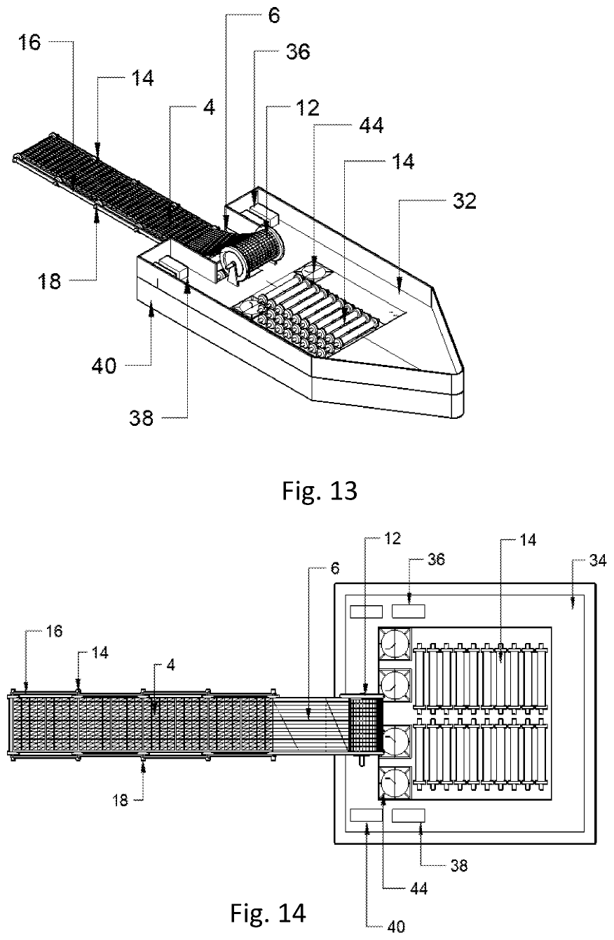

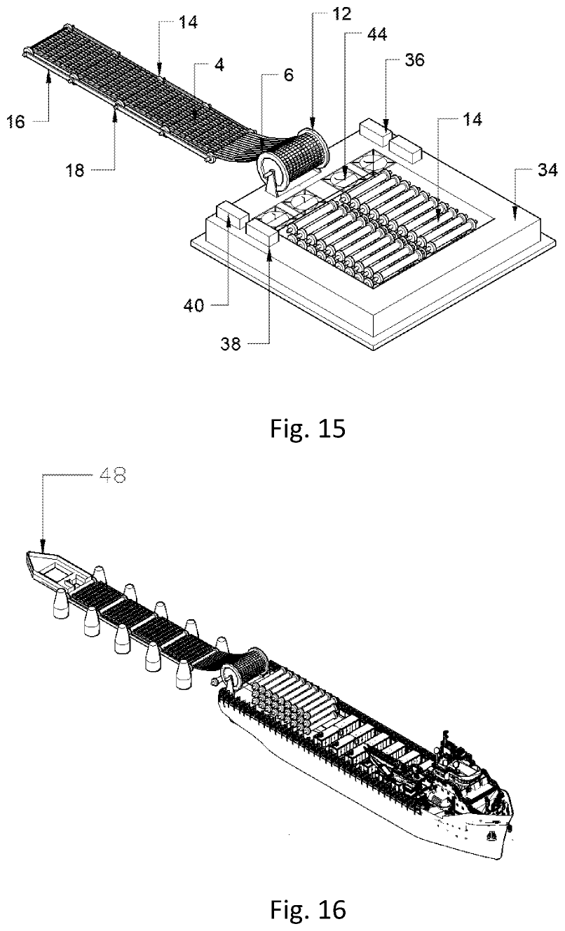

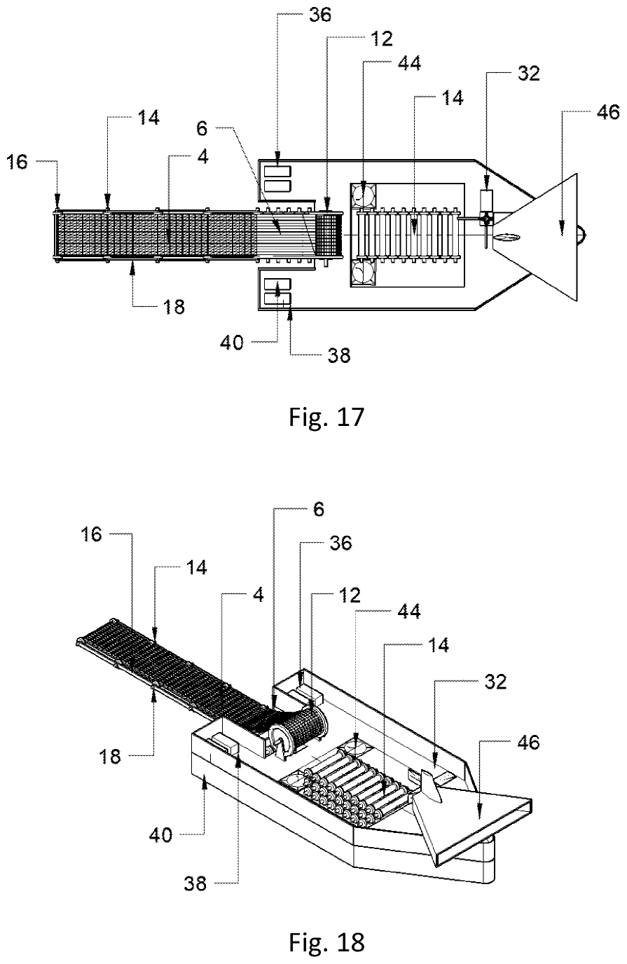

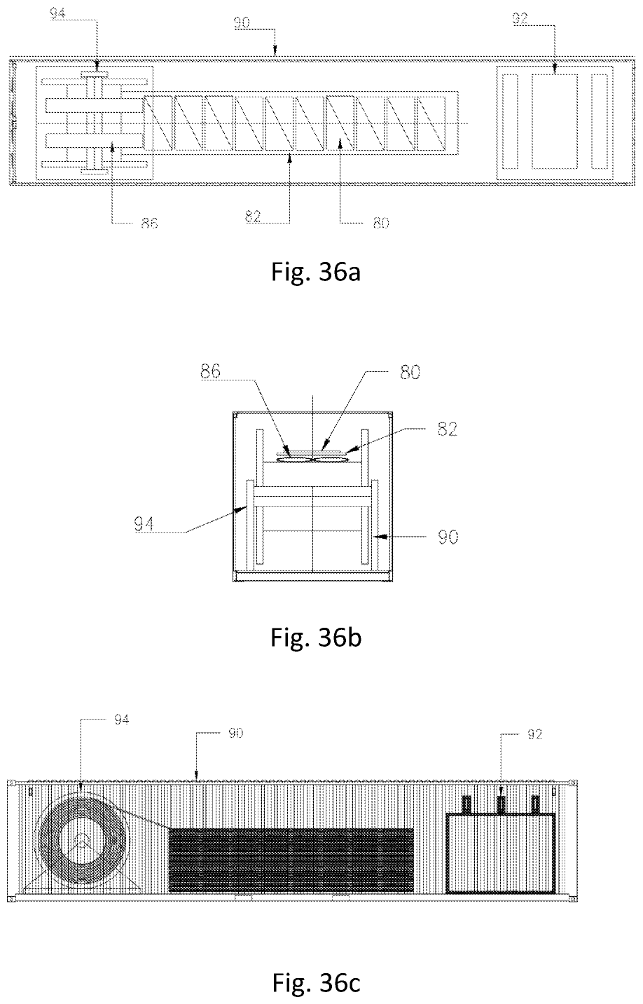

Referring now to FIGS. 1 to 36c, there are described a solar power system 2, solar power plant and method of using the solar power system according to preferred embodiments of the present invention.

As illustrated in FIGS. 1a and 1b, the solar power system 2 comprises at least one solar panel 4, such as a photovoltaic panel, and a support structure on which the at least one solar panel 4 is mounted. The support structure is adapted so as to be retractable into a compact configuration for storage and deployable into an extended configuration for generation of solar power. In the following examples discussed in more detail below, the solar power system 2 can be installed on a vehicle, such a marine or fresh water watercraft thereby forming a floating off-shore power plant or a land vehicle thereby providing a portable power plant. The support structure can be arranged so as to be deployed over a surface such as water or land which can advantageously increase the surface area for maximal power generation by the solar panel(s) 4.

At least part of the support structure is adapted so be fillable with a fluid. The fluid can be water, such as fresh or sea water, air or other gases, such as helium. By filling the part of the flexible support structure with fluid, the properties of the support structure can be adjusted to suit the power delivery requirements. As detailed in the following paragraphs, the properties of the support structure, such as flexibility or buoyancy or weight, can also be changed so as to assist in deploying the solar panels 4 or in arranging the support structure in a compact configuration.

The support structure can be in the form of a flexible substrate. In the embodiment illustrated in FIGS. 1a and 1b, the flexible substrate can be in the form of one or more fluid-fillable members such as a collapsible hose 6 (also known as a ‘layflat’ hose) as illustrated in FIGS. 1a, 1b, 5, 6, 19 to 22, 34 and 35.

The flexible substrate in any of the embodiments described below can comprise a sheet of flexible material in addition to or substituted for the at least one fluid-fillable member. The flexible material or fluid-fillable member 6 can comprise material that can be one or more of the following: a polymer material such as polyurethane, particularly thermoplastic polyurethane, PVC, polypropylene, and the like, woven material such as cloth or a combination thereof. It would be appreciated by a person skilled in the art that materials will be chosen for their suitability for particular environments such as resistance to sunlight, salt water corrosion and the like. For example, the materials may include use of ethylene tetrafluoroethylene (ETFE) is a lightweight material which is an alternative to glass where UV transmission is required.

As shown in the particular embodiment of FIGS. 2 to 5, the support structure comprising the fluid-fillable member 6 has a plurality of solar panels 4 mounted thereon installed on a ship 20 thereby forming a solar plant. The solar panels 4 are arranged on an upper most surface of the fluid-fillable member, such as the hose 6 such that the solar panels 4 face upwardly towards the sun when deployed.

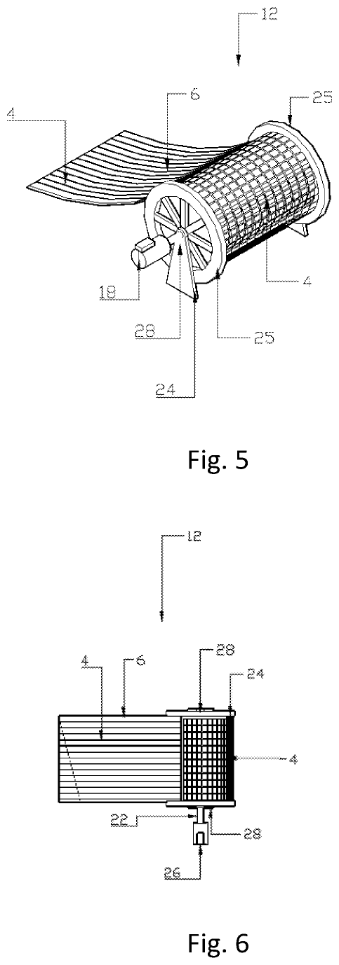

As shown in the example of FIGS. 5 and 6, the solar power system 2 includes a reel assembly −12 which includes a reel −24 onto which the length of collapsible hose 6 is wound onto the reel −24 so that the sheet material 6 and solar panels 4 are in a compact configuration. The collapsible hose 6 forms an elongated strip on which an array of solar panels 4 is mounted which is a convenient for winding onto a reel −24. It is preferred that the solar panels 4 are also flexible. The flexibility of the collapsible hose 6, when empty, and solar panels 4 allows the collapsible hose 6 and solar panels 4 to be wound easily onto the reel −24. The diameter of the reel −24 is configured to be sufficient large enough so as to allow bending of the collapsible hose 6 and solar panels 4 onto the reel −24 and unwound from the reel −24 without damage. By unwinding the collapsible hose 6 and solar panels 4 from the reel −24, the solar panels 4 can be deployed into an extended configuration for exposure to the sun thereby allowing power generation.

In the embodiments illustrated in FIGS. 2 to 15, the support structure is configured to support the solar panels 4 on or above the surface of the water by having at least part of the support structure which is fillable with a fluid such as air or other gases that effect positive buoyancy. As such, the continuous strip is supported by a rack-type arrangement for providing buoyancy which includes multiple containers which are fillable with gas. Alternatively, the fluid can be water so as to act as ballast. In this example, the rack-type arrangement comprises a number of equidistantly-spaced support members 14 which are located laterally under the solar panels 4 connected together by linking members 16 therebetween and pins 17 and a number of buoyancy members 18 which can be in the form of buoys which are attached at opposite ends of the support members 14 to effect positive buoyancy. The linkage nature of the rack-type arrangements also provides flexibility which is advantageously to flex vertically with the sea or ocean waves.

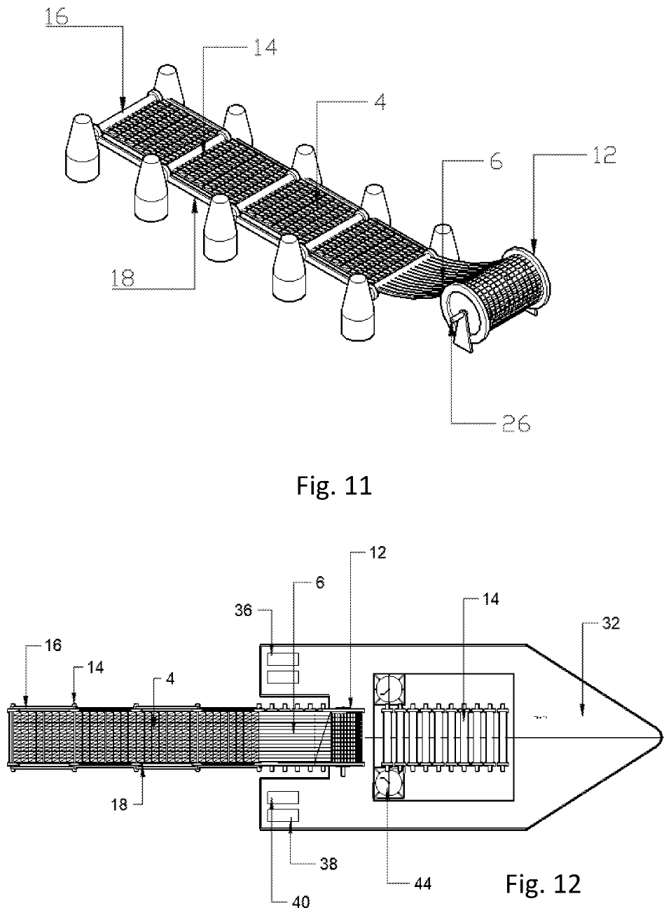

In FIGS. 10 and 11, the buoyancy members, namely the buoys 18, can be configured to be height adjustable for supporting the solar panels 4 above the surface of the water. In other embodiments, the buoyancy members 18 can be adjusted to extend or retract vertically to raise and lower the support members 14 thereby selecting between a configuration where the solar panels 4 are supported above the water and another configuration where the solar panels 4 are at or near the water surface to account for different sea conditions or for additional protection when necessary. The buoyancy members 18 can be adjusted to raise and lower the solar panels 4 by increasing or decreasing the pressure of the gas in the containers thereby effecting a change in the buoyancy thereof. As exemplified in FIGS. 11 and 16, there are buoyancy members 18 which have been extended such that the deployed solar panels 4 are in a raised condition.

It is particularly advantageous when the solar power system 2 as described in the above paragraphs is installed on a vehicle, such as a ship 20 as illustrated in FIG. 2 to 5 or a floating platform 32, 34, 36 as shown in FIGS. 12 to 15 and 17 to 18, to form a solar power plant. As shown the reel assembly including the solar power system 2 is mounted at the stern allowing the continuous strip to be deployed from the reel −24 such that it extends behind the ship 20 with the solar panels 4 facing upwards for the generation of power from the sunlight which is held above or at the water surface by the support structure. The reel 10 has a central core having a driving shaft 22, end discs 25 and geared drive 26 that are supported in a bearing arrangement 28 with a number of spokes 30 radiating from the central core. The shaft 22 can be electrically, pneumatically or hydraulically driven.

When required, for example, in any adverse weather conditions, the solar power system 2 can then be wound into a compact configuration onto the reel −24 which is advantageous in allowing the solar panel system 2 to be stored, easily and conveniently movable and prevents damage in the adverse weather conditions. The compact configuration is also in a convenient arrangement when transporting the solar panel system 2 from the factory to its location of use.

The off-shore solar power plant 32 also advantageously provides a way of avoiding procurement a large area of land for installation of the power plant and can provide a power plant to be located close to populations at remote islands or coastal communities. In addition, the off-shore solar power plant can include a hydrogen plant 36 which generates hydrogen by electrolysis and provided with a reverse osmosis desalination plant fed by the seawater lift pumps. The generated hydrogen is either compressed by on board Hydrogen compression skid 38 and or converted to ammonia or such for offloading. The oxygen generated can also be compressed and used as required. As hydrogen and oxygen are extremely flammable gases, the offshore nature advantageously locates the plant away from densely populated areas. The power generated is sent to a power conditioning/management module 40 to stabilise the power which can then be sent to the hydrogen plant 36 or stored in batteries. For additional power generation, the ship 20 and platforms 32, 34 can include a wave energy converter 44 and/or wind turbine 46.

In a particularly preferred example of a solar power plant or system as described in FIGS. 1 to 11 having solar panels of dimensions 1.5 m×0.50 m that can be fitted on to a collapsible hose 6 with a total continuous length of 100 m and a width of 0.60 m such that an appropriate clearance will be 62 mm. Given the flexibility and dimensions of the solar power system 2, the reel assembly is expected to have a reel 24 of a diameter of 6 m. The circumference of this diameter will be 18.846 m thus to fully wind the solar panel system 2 on the reel assembly will be 5.3 turns (100 m/18.846).

As the thickness of the collapsible hose 6 and solar panels 4 if required will be around 15 mm or 0.015 m (including a protective coating), the thickness of the number of turns, in this example being 5.3 turns×thickness of the system (0.015 m) provides an increase in diameter of 0.015 m×5.3 turns×2 (top and bottom)=0.159 m. The total diameter will then be 6 m+0.159 m=6.159 m Thus, for a solar panel system 2 having a length of 1000 m, which will be 10 times the length in the above example will yield a
Total number of solar panels: 620
Total length of collapsible hoses: 1000 m
Number of turns: 53
Thickness of this number of turns: 1.59 m
Increase in diameter: 7.59 m
Assuming also the output per solar panels of 140 watts
Total Power per length (1000 m) of solar panel s4 on length of collapsible hose 6 =86.8 kW

The width of the collapsible hose 6 in this example is 0.60 m and a number of this will be provided in parallel to provide for a larger number of installed solar panels 4. Assuming the width of the reel is 12 m, the system 2 has the following estimated specifications:
Width of reel: 12 m
Width of collapsible hose: 0.60 m
Number of collapsible hose that can be installed: 20
Total Power output per solar panel system: 1,736 kW

Thus, the solar power system 2 provides for a power generation system that is easily deployable from a conveniently compact configuration, has a large surface area for solar power generation which in turn and as a consequence provides for a larger power output as mentioned in the example, that which is also readily retracted into a compact configuration for protection under rough weather conditions.

Referring now to the embodiment illustrated in FIGS. 12 to 18 there are shown a number of arrangements where the solar power plant described above is installed on a number of off-shore type vehicles, including a ship 20 (FIGS. 2 to 4, 26, 27a. 26b and 32), ship-shaped and square-shaped floating platforms 32, 34 having a moon-pool (FIGS. 12 to 15). A tow-boat 48 can be used at the remote end of the continuous strip to assist in deployment of the solar panel system (FIG. 16). These embodiments illustrate that the various types of vehicles 20, 32, 34 can also accommodate other power generation apparatus, such as a wave energy converter 44, cross flow wind turbine generator 46, water desalinisation plant (not shown) and hydrogen plant 36.

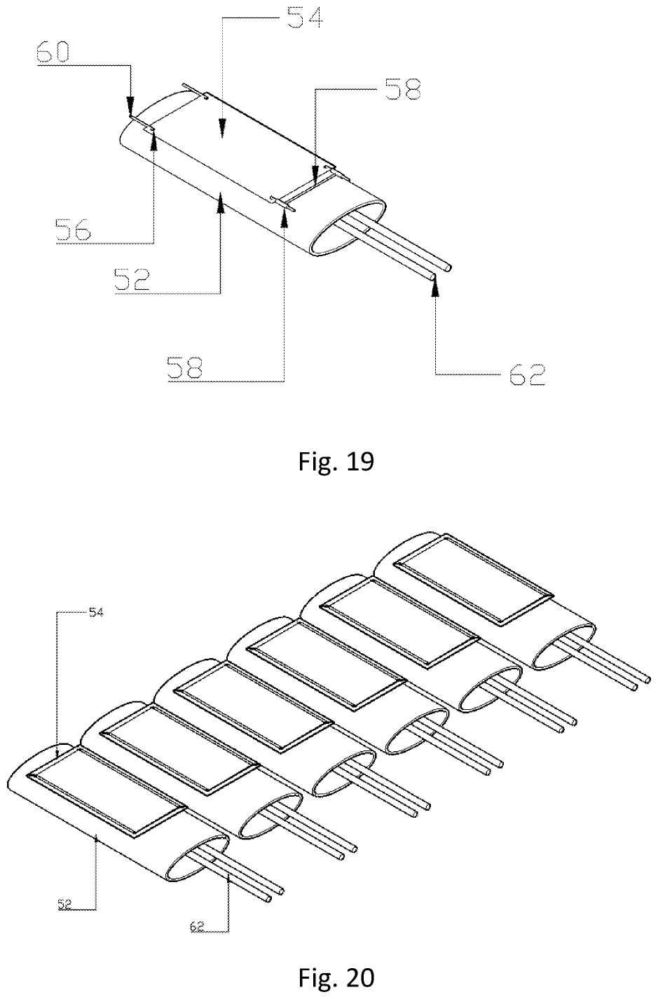

Referring now to FIGS. 19 to 25, there is shown a solar power system 50 according to another preferred embodiment where the support structure comprises at least one fluid-fillable member, such as a collapsible hose 52 which can be plugged at its ends. The fluid-fillable member is adapted so as to be fillable with a fluid which can change the properties of the support structure according to the conditions.

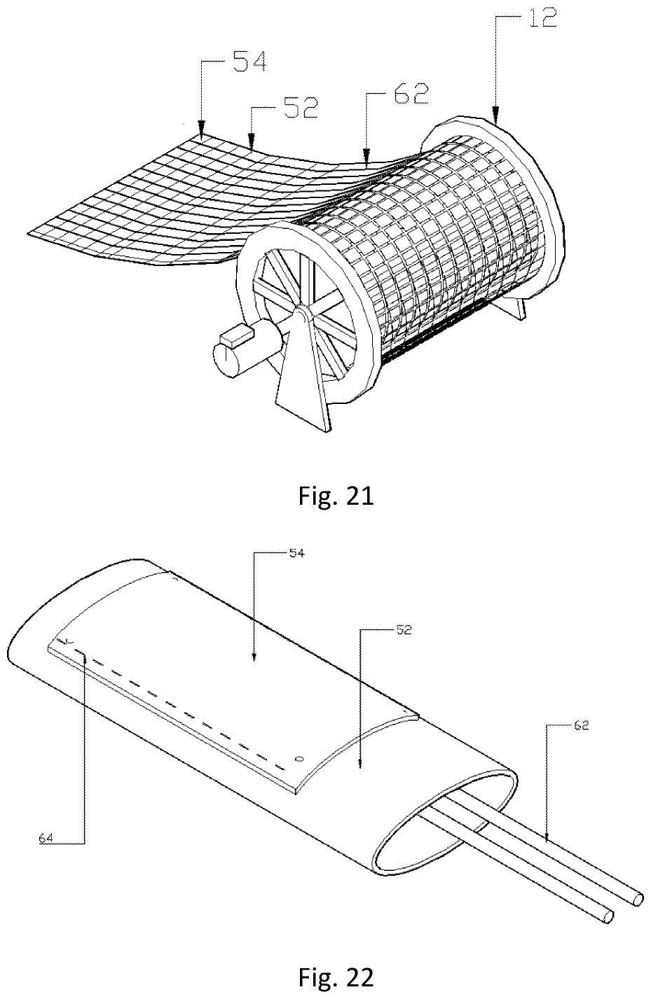

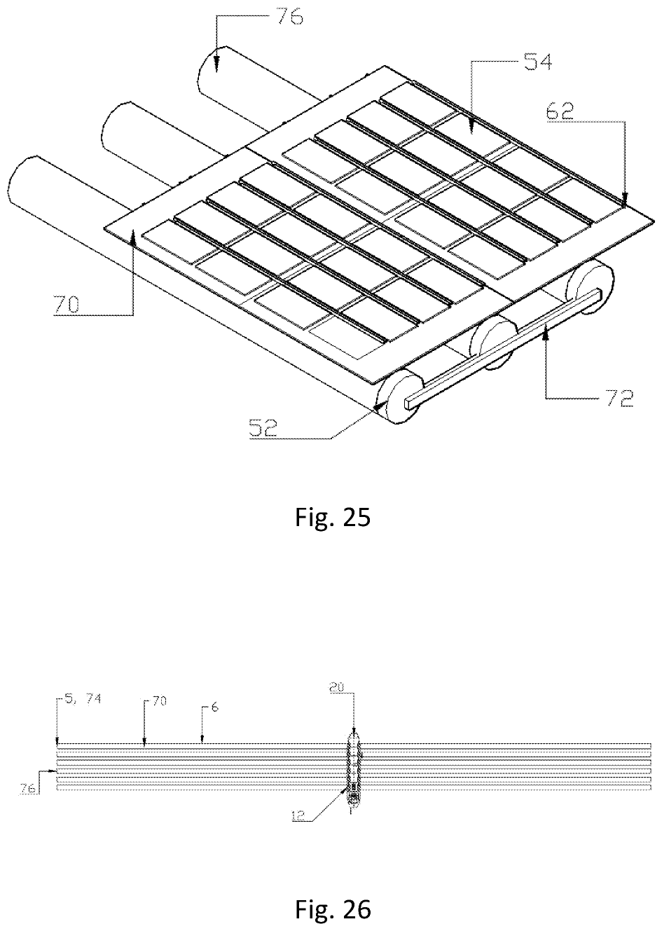

FIG. 24 shows the collapsible hose in an empty or un-filled condition while FIG. 25 shows the collapsible hose 52 when filled with compressed air and closed at one end by a plug member. By filling the collapsible hose 52 with air, the buoyancy of the deployed solar panel system 50 is increased so as to allow the solar panel system 50 to float on the water surface. Alternatively, when the solar panel system 50 is used in a land-based environment, the collapsible hose 52 or hoses can be filled with water to increase its rigidity and stability on the ground. When desired, the solar panel system 50 can easily be retracted into its compact configuration by removing the compressed air or reducing its pressure, or by removing the water or other fluid. When the collapsible tube is empty, it collapses and becomes flexible allowing the solar panel system 50 to be retracted into the compact configuration onto a reel, as illustrated in FIG. 21, to protect it from the elements or to be removed to another location as desired.

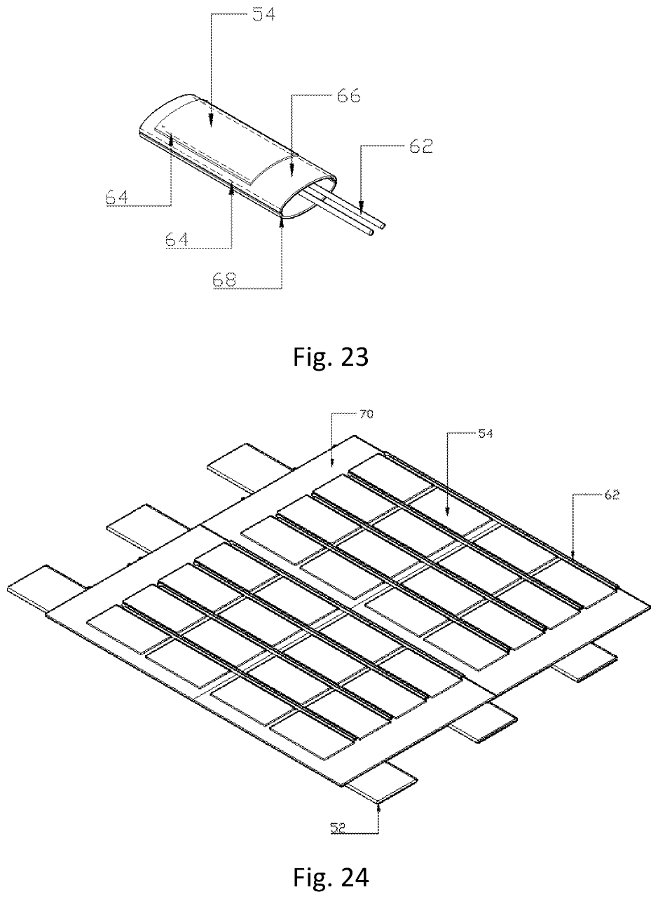

The solar panels can be connected or attached to the support structure by a variety of ways, such as fasteners, such as an eyelet 56, spacer tube 58 and polymer rope arrangement as illustrated in FIG. 19. Alternatively, fasteners such a belt, or bracket, and/or stitching with polymer thread to a substrate as illustrated in FIGS. 23, 24, 33 and 34. The stitching can then be sealed by a sealant thereafter, such as an epoxy resin or similar. It can be understood that other methods of fixing the at least one solar panel to a substrate or collapsible hose could be used as appropriate but not limited to adhesives or mechanical fasteners such as crimps, rivets, bolts and similar.

The solar panel system 50 can also comprise a plurality of collapsible hoses 52, each of which can be provided with a series of solar panels 54 connected end to end along its length on one side of the hoses 52. The solar panels 54 can be electrically connected by power cables 62. As illustrated in FIG. 20, in a preferred embodiment, there are a number of collapsible hoses 54 which are laid edge to edge in a parallel configuration. As each of these collapsible hoses 54 are provided with a series of solar panels 56, the parallel configuration of multiple collapsible hoses 54 therefore provides an array of solar panels 56 such as that shown in FIG. 21.

In FIG. 23, the substrate comprises a pair of polymer sheet material 66, 68 having the solar panels 54 provided on an upper polymer sheet 66 such that the solar panels 54 face upwardly for exposure to the sun. The upper and lower sheet material 66, 68 are provided face to face for additional protection from the water and are fixed together by a variety of means including stitching by polymer thread 64 as illustrated.

Alternatively, in another embodiment shown in FIGS. 24 and 25, the support structure comprising a plurality of collapsible hoses 52 has an array of solar panels 54 on a polymer sheet 70. Advantageously the collapsible hoses 52 can be located further apart in this embodiment. An attachable brace member 72 (assists to hold the solar panel system rigid laterally when deployed) and can be removed as needed especially when the system is being retracted into the compact configuration.

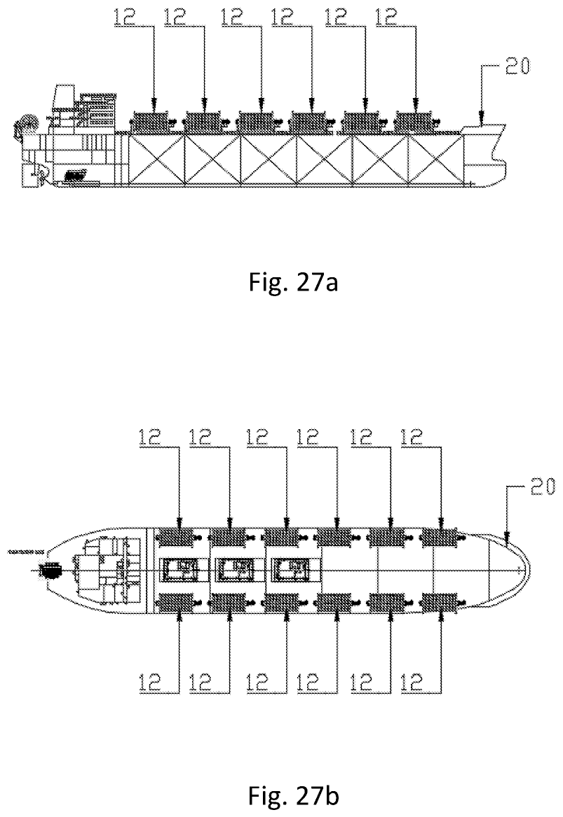

FIGS. 26, 27a and 27b shows an alternative embodiment where a marine or fresh water vehicle 20, is installed with multiple solar panel systems 2, 50 as discussed in the above paragraphs. Each of the solar panel systems 2, 50 can be stored in a compact configuration on a reel and the vehicle 20 can be provided with two rows of reels, where each row of reels can be installed equidistantly on opposite sides of the vehicle 20, namely port and starboard. Once deployed, the solar panel systems 2, 50 can then extend in multiple parallel lines on either side of the vehicle 20 to provide maximal coverage of an area for optimal power generation. The ends of the fluid-fillable members 52 are closed by plug members 74 and the held equidistantly together by support member 76.

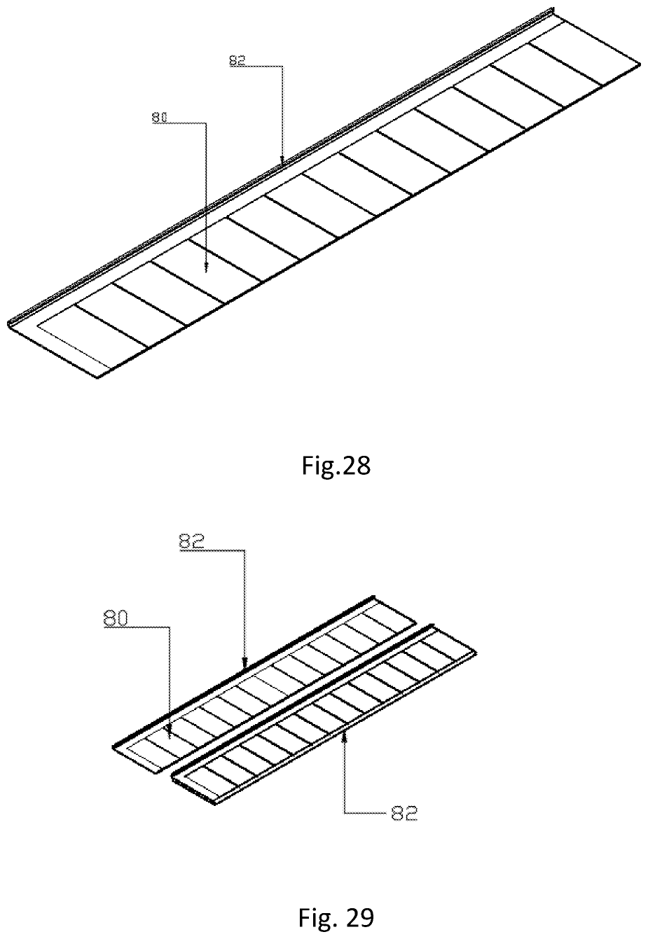

Referring now to FIGS. 27a to 36c which show another solar power system 78 and solar power plant according to further preferred embodiments of the present invention. The solar power system 78 comprises a support structure for supporting the solar panels 80 which is supported by support structure in the form of panels of sheet material 82, preferably flexible sheet material. Each of the panels of sheet material 82 can support multiple solar panels 80. The examples of FIGS. 28 to 36c show a single row of solar panels 80 supported by each panel 82 of sheet material however it should be understood that the panels of sheet material 82 could support different configurations of solar panels 80 such as an array depending on the energy requirements, solar panel size, sheet material and other similar factors.

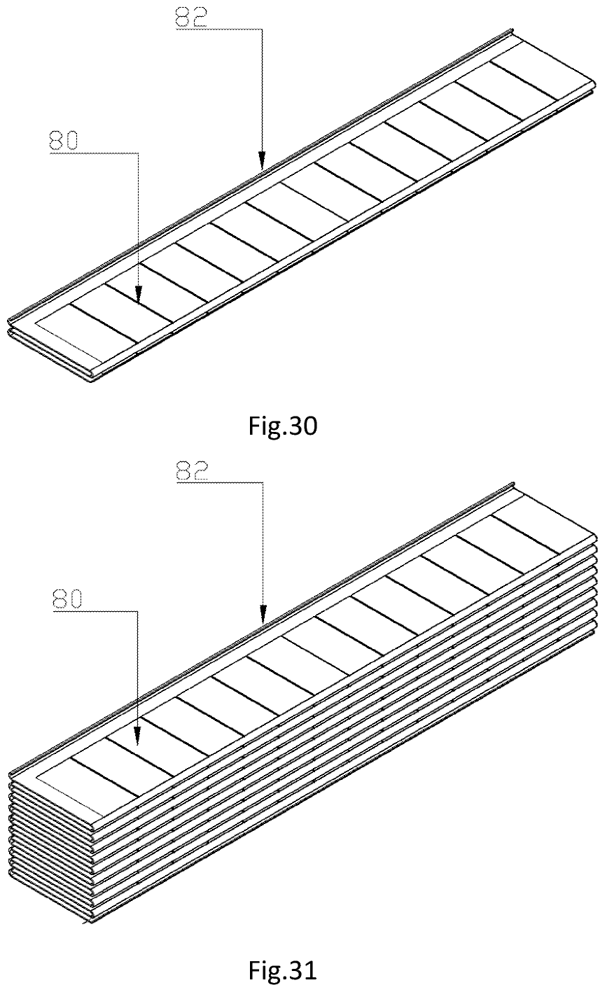

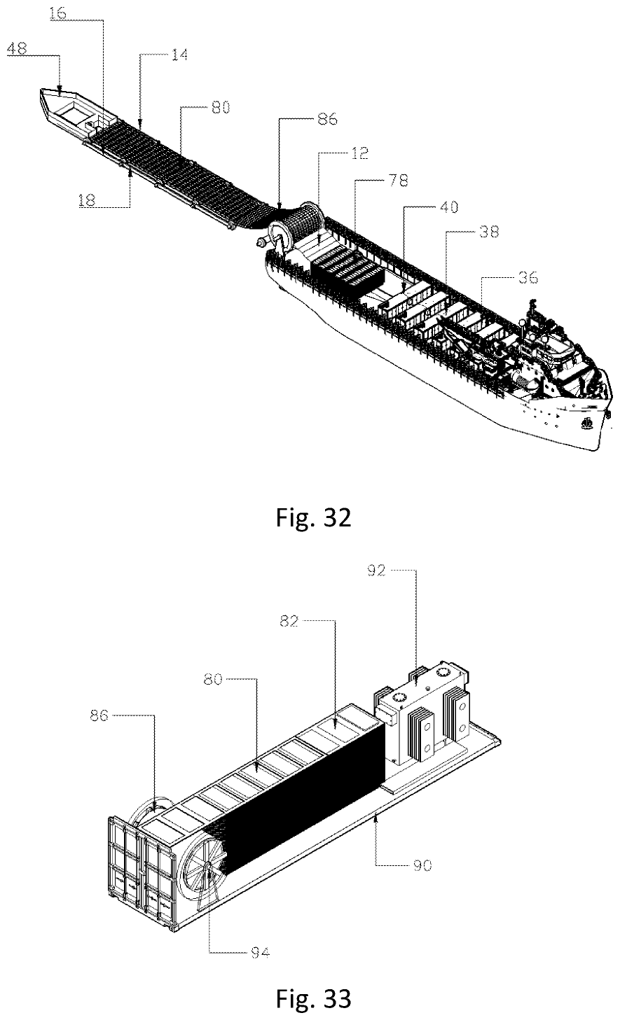

As illustrated in FIGS. 30 and 31, the panels of sheet material 82 can be arranged in a compact configuration of a stack of panels 82, namely where the top face of one panel 82 is in contact with a bottom face of a panel 82 stacked above it. In one particular preferred embodiment, the panels 82 are connected at adjoining edges so as to form a concertina arrangement which conveniently allows unfolding of the connected panels 82 into a deployed configuration and then folding of the connected panels 82 in a compact or stacked configuration. FIG. 32 shows the solar power system 78 installed on a ship where the panels are spooled onto a reel which is used to deploy the panels from the stern of ship 84.

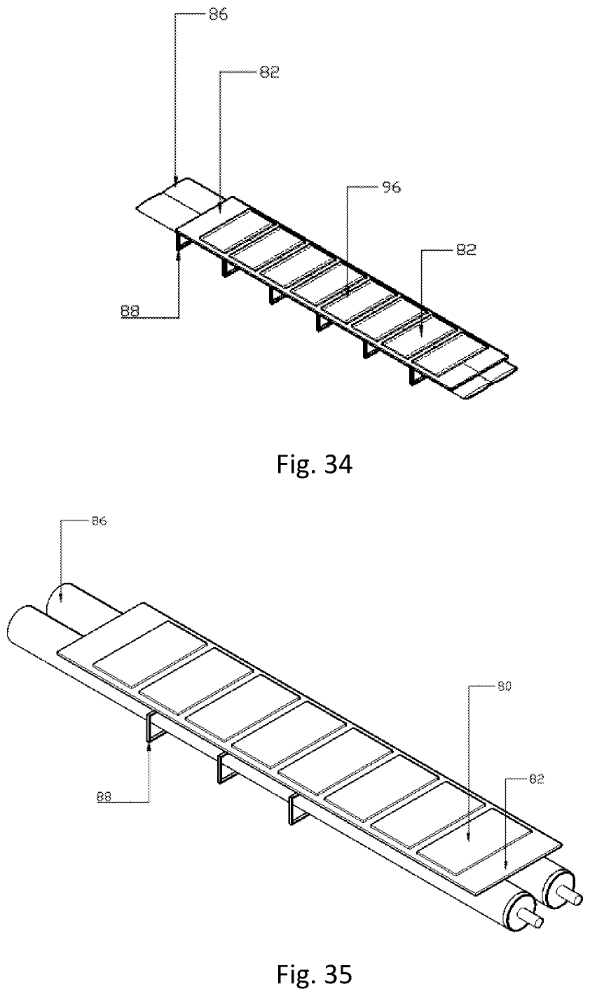

The example illustrated in FIGS. 33 to 36c shows solar panel system 78 further including a pair of parallel collapsible hoses 86 under the panels 82 to support the solar panels 82 on or above the water surface. The panels of sheet material 82 can be fixed to the collapsible hoses 86 by a series of brackets 88. When deploying or retracting the solar panel system 80 between the compact and deployed configurations, the collapsible hoses 86 are unfilled so that the solar panel system 78 is at its most flexible to allow it to be deployed by the reel (see FIG. 34). Once deployed, the collapsible hoses 86 can then be filled with compressed air or water such that the solar panels 82 are raised above the deployment surface, for example a water surface for the avoidance of waves as shown in FIG. 35. When the collapsible hoses 86 are filled with water, the water can act as a ballast. Only two collapsible hoses 86 are illustrated in this example, however it would be expected that any number of hoses could be provided as necessary.

In a particular preferred embodiment, when housing the solar power plant on a roof, the collapsible hoses can be filled with helium for reduction of system weight. Furthermore, the pressure of the fluid in the support structure can assists in controlling the angle of the solar panel system with respect to the surface on which the system is deployed.

The solar panel system 78 is preferably housed in an enclosure 90, such as a 20 or 40 ft container, which can accommodate the stack of panels of sheet material 82 attached by stitching 96 and reel 94 thereby forming a solar power plant which can be easily installed on a ship or land-based vehicle. In another embodiment, the solar panels 82 can be electrically connected in series which produces a high voltage output thereby necessitating a HVDC transformer 92 to step the voltage down to any required specification. The enclosure 90 is therefore also configured to house the HVDC transformer 92 and any necessary wiring or ducting, cable termination and instrumentation (not shown for ease of illustration). The enclosure can be a 20 or 40-foot container for convenience.

It can be advantageous that the system includes a HVDC transformer 92. As conventional systems require the use of inverters which have a limiting DC voltage and thus this limits the number of panels that can be connected in series, it can be beneficial that the system has panels which are connected in series to allow for a greater number of panels. Series connection is an important aspect of some embodiments of this technology as it enables factory wiring of the solar panel system and minimise the wiring required in the field. The HVDC transformer 92 may comprise a DC to AC Converter and then an AC Transformer to condition to grid or other power requirement.

In a particular example of the solar panel system 50 and solar plant as illustrated in FIG. 33. to 36c, there are provided 2041 flexible solar panels 80 having dimensions 1050 mm in length and 540 mm in width with a thickness of 2 mm with a total power output 200 kWwith power per panel of 120 W, as detailed in the following table.

TABLE 2
Example solar power plant specifications

| Power required | 200 | kW |
|---|---|---|
| Power per panel | 120 | W |
| Efficiency | 98% | |
| Output per panel | 117.6 | W |
| System efficiency | 20% | |
| No of panels | 2041 | |
| Length of panel | 1050 | mm |
| Width of panel | 540 | mm |
| Thickness | 2.5 | mm |
| Clearance between panels | 10 | mm |
| Area per panel | 0.6 | sq m |
| Total area | 1190 | sq m |
| Array length | 2 | m |
| Array width | 595 | m |
| Thickness of panel | 3 | mm |
| Thickness of sheet material | 3 | mm |
| Cushion thickness | 2 | mm |
| Bend width of polyester sheet | 2 | mm |
| Total thickness | 10 | mm |
| Clearance between panels, length | 0 | mm |
| No of panel in line | 1 | |
| Total length | 1050 | mm |
| No. of panels per sheet material | 8 | |
| Output per sheet material | 0.9408 | kW |
| Power required | 200 | kW |
| Number of sheet material | 255.102 | |
| Stack height estimated | 2551.02 | mm |
| Total length of sheet material | 1153 | m |

In an example method of use of the solar power systems and plants as described above, there is provided a support structure on which solar power panels are mounted. The support structure can comprise sheet material or fluid-fillable members or both, and where the support structure and solar panels are configured to be flexible. In particular, when prepared at the factory, the support structure and solar panels are sufficiently flexible so as to wound onto a reel or stacked configuration for convenient transportation and which also serves to protect the system from damage during that time.

The solar power system can then be installed in a variety of land or marine vehicles or locations, such as barges, ships, tugs, roofs, trucks and the like. Once connected to the appropriate wiring and infrastructure, the installed solar power systems thereby form a portable or fixed power plant having a power system which is available in a compact configuration which can be deployed to take advantage of any open area available including water surfaces or land surfaces or even roofs. Thus, in the examples, the offshore power plants can be installed in open water and the solar panels deployed to maximise the area from which solar power can be generated as illustrated in FIGS. 2, 10, 13 to 18, 26 to 27b and 32.

The power generated can be used to power a hydrogen plant provided on the vehicle or on location or a desal plant. The power generated can also be stored in batteries on-site.

The support structure is also configured to be fillable with a fluid, such as gas or water, which can act to adjust the properties of the support structure. The support structure can have fluid-fillable members, such as one or more buoyancy members or collapsible hoses. When empty of fluid, the support structure is at its most flexible which lends itself to be returned to be wound onto a compact configuration, such as onto a reel. However, when the solar power system is in its deployed condition, filling the support structure with gas can assist to effect changes in buoyancy, for example raising the solar panels above the water surface to keep them from damaging waves or to adjust the angle at which the solar panels are mounted. Filling the support structure with water may also assist in providing needed ballast. Thus, by filling the support structure with a fluid, and by selecting the fluid and its pressure in the support structure, the properties of the solar panel system can be advantageously adjusted as necessary.

When necessary, the solar panel system can then be retracted or returned to the compact configuration by removing any gas or water therein to increase its flexibility, such as when there are adverse weather conditions expected, or to move the solar power plant itself. Thus, the system and plants herein described provide the advantages of an easily deployable solar system and plant which can be deployed on or offshore to take advantage of any available area, can be deployed in a configuration for maximising the solar power area for exposure, yet be returned to a compact configuration for protective or transportation purposes.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be understood to persons skilled in the art of the invention that many modifications may be made without departing from the spirit and scope of the invention.

1. A solar panel system comprising:
at least one solar panel; and
a flexible support structure supporting the at least one solar panel;
wherein at least part of the flexible support structure is configured to be fillable with a fluid.

2. The solar panel system according to claim 1, wherein the at least part of the flexible support structure is configured to be fillable with the fluid for adjustment of buoyancy, weight, or an angle of the solar panel system with respect to a surface on which the solar panel system is deployed.

3. The solar panel system according to claim 1, wherein the at least part of the flexible support structure is filled with gas or water.

4. The solar panel system according to claim 1, wherein the at least part of the flexible support structure is configured to be fillable with the fluid or is able to be emptied for adjustment of flexing properties of the flexible support structure.

5. The solar panel system according to claim 1, wherein the pressure of the fluid is adjustable for adjustment of buoyancy, weight, or an angle of the solar panel system with respect to a surface on which the solar panel system is deployed.

6. The solar panel system according to claim 1, wherein the flexible support structure at least partly comprises at least one collapsible hose.

7. The solar panel system according to claim 1, further comprising a flexible sheet of material intermediate the flexible support structure and at least one solar panel.

8. The solar panel system according to claim 1, wherein the at least the part of the flexible support structure comprises at least one buoyancy member.

9. The solar panel system according to claim 8, wherein the at least one buoyancy member is configured to be extendable so as to raise or lower the support structure between a configuration where the at least one solar panel is supported above the fluid and another configuration where the at least one solar panel is at or near a surface of the fluid, wherein pressure of the fluid in the at least one buoyancy member is adjustable to effect extension or retraction of the at least one buoyancy member.

10. The solar panel system according to claim 1, wherein the flexible support structure is adapted so as to be retractable into a compact configuration for storage and deployable into an expanded configuration for generation of solar power.

11. The solar panel system according to claim 10, wherein the flexible support structure is filled with the fluid when deployed for effecting rigidity and further wherein the fluid is removable for retraction into the compact configuration.

12. The solar panel system according to claim 10, further comprising a reel assembly having a reel member, wherein the flexible support structure is configured so as to be wound onto the reel member into the compact configuration and unwound from the reel member so as to deploy the solar panel system into the expanded configuration.

13. The solar panel system according to claim 10, wherein the support structure comprises a series of sheet material, each sheet material being in a form of a panel, each of the panels of sheet material supporting one or more solar panels of the at least one solar panel, and wherein the panels of sheet material are connected to one another so as to be foldable into the compact configuration and unfoldable so as to be deployed in the expanded configuration.

14. The solar panel system according to claim 1, configured for deployment on a roof of a house or for off-shore use.

15. (canceled)

16. (canceled)

17. A solar power plant comprising one or more of the solar power systems according to claim 1 installed on a land vehicle, wherein the one or more of the solar panel systems are deployable on land, or on a roof of a house.

18. A method of using a solar power system comprising at least one solar panel and a flexible support structure supporting the at least one solar panel: said method comprising:
deploying the flexible support structure into an expanded configuration for generation of solar power; and
retracting the flexible support structure into a compact configuration.

19. The method according to claim 18, wherein the flexible support structure is fillable with fluid, and wherein method further includes:
filling the support structure with the fluid for adjustment of properties of the support structure when deployed.

20. The method according to claim 19, further comprising removing the fluid from the support structure for retracting the flexible support structure into the compact configuration.
